(19) United States
(12) Patent Application Publication
(10) Pub. No.: US 2020/0310470 A1
(43) Pub. Date: Oct. 1, 2020

(54) CONFIGURABLE VALVE FOR DISTRIBUTING A FLUID AND METHOD FOR SETTING THIS VALVE

(71) Applicant: Parker Hannifin EMEA S.à.r.l., Etoy (CH)

(72) Inventor: Jean-François Viste, LA BONNEVILLE SUR ITON (FR)

(21) Appl. No.: 16/754,878

(22) PCT Filed: Oct. 10, 2018
(86) PCT No.: PCT/EP2018/077630

§ 371 Date: Apr. 9, 2020

(30) Foreign Application Priority Data
Oct. 13, 2017 (FR) 17/59609

(51) Int. Cl. G05D 7/06

(52) U.S. Cl. CPC G05D 7/0623; G05D 7/0652

(57) ABSTRACT

This valve (1) is intended to be mounted on a base for the purpose of controlling the distribution of a fluid, and comprises a housing (2) and a plurality of orifices (0), these orifices (0) being intended for the inflow or the outflow of the fluid inside the housing (2). The valve (1) additionally comprises a plurality of distributors (4) arranged in the housing (2) so as to control the flow of the fluid inside the valve (1), and the valve (1) comprises an electronic card (6) arranged in the housing (2), the electronic card (6) being configured so as to store a truth table (60) associating a predetermined position of the distributors (4) with each control signal received by the valve (1). The electronic card (6) is furthermore configured so as to manage a transition mode of the distributors (4) from one position to another.

The present invention concerns a valve for distributing a fluid, a device for distributing a fluid comprising this valve, as well as a method for setting this valve.

Conventionally, a fluid valve, such as for example a pneumatic solenoid valve, comprises several orifices serving for the intake or outlet of the fluid, and means for switching and monitoring the circulation of the pressurized fluid. A fluid distributor is traditionally configured to accomplish a single predetermined fluid distribution function, that is to say that in response to the same control signal, the fluid valve distributes this fluid at the outlet always in the same way through the base on which this valve is mounted.

A drawback of these conventional fluid distribution devices is that it is necessary to change the valve each time the user wishes to modify the function executed at the outlet. This therefore requires the user to dispose one valve per function, which generates constraints in terms of stock, maintenance or change in production rate.

The present invention therefore aims to overcome this drawback by proposing a fluid distribution valve capable of performing a plurality of distinct functions.

To this end, the present invention relates to a valve intended to be mounted on a base for monitoring the distribution of a fluid, this valve comprising a housing and several orifices, these orifices being intended for the inlet or the outlet of the fluid inside the housing, characterized in that the valve comprises a plurality of distributors arranged in the housing to monitor the circulation of the fluid inside the valve, and in that the valve comprises an electronic card arranged in the housing, the electronic card being configured to memorize a truth table associating to each control signal received by the valve a predetermined positioning of the distributors.

Thus, the positioning of the distributors in response to an inlet signal depends on the truth table stored in the electronic card, so that the valve according to the invention is capable of accomplishing alone several distinct functions, one function being defined by a truth table. There is no need to change the valve to change the function as is the case in the prior art. It is enough to modify the function saved by the electronic card. It should also be noted that the valve according to the invention operates autonomously and transparently for the user, the outer control signals remaining standard.

According to one embodiment, the device comprises connection means configured to allow connecting the electronic card to a user terminal for transferring a truth table from the user terminal to the electronic card.

This makes it possible to transfer, from this user terminal, another truth table to the electronic card. Thus, the user may modify the truth table stored in the electronic card at his discretion, by connecting the electronic card to the user terminal, so that the pilot signals delivered to the distributors by the electronic card will be modified in response to the outer control signals.

According to one embodiment, the device comprises means for recycling fluid configured to recover at least one portion of the fluid purged by one of the distributors for its reuse.

This allows substantial energy savings.

According to one embodiment, the electronic card is configured to manage a transition mode of the distributors from one position to another.

This allows defining a sequencing, that is to say an order to open or to close the inlet or outlet channels of the distributors, or a speed of transition of the distributors from one position to another.

Conventionally, in a fluid distribution valve of the prior art, the transitions from one state to another are defined by technological choices and by the mechanical arrangement of the valve in question, and are thus immutable. In the case of a pneumatic valve for example, the switchover from the state in which a first outlet port is pressurized and a second outlet port is exhausted, to the state in which the first port is exhausted and the second port is pressurized, or vice versa, is produced in a synchronized manner because the mechanical construction generally employed combines and connects between them the establishments for the passage of fluid. The use of the electronic card to control the plurality of distributors, in relation to the truth table implemented via the user terminal, makes it possible to adapt the changes of states depending on the needs of the user, and thus to bring temporal or conditional, adjustable and modifiable offsets.

According to one embodiment, the valve comprises means for measuring pressure or flow rate which are connected to the electronic card.

This makes it possible to optimize the transfer of fluid from one distributor to another so as not to have a detrimental impact on the response times of the valve at an inlet signal, in particular in the case of fluid recycling. In this case, the differential measurement of the pressures between the outlet orifices or that of the fluid flow rate makes it possible to adjust and optimize the time necessary for fluid recycling, while respecting the desired cycle time. This arrangement also makes it possible to implement conditional offsets based on the values of pressures or flows during transitions from one state to another. These parameters are inner to the valve and managed by the electronic card and therefore do not require additional equipment in the installation of the user or additional outer control logic.

According to one embodiment, the valve comprises an electrical energy storage element embedded in the housing and configured to supply energy to the electronic card.

Thus, the valve offers more use opportunities, and it is moreover compatible with already installed systems, within the context of maintenance or improvement operations.

According to one embodiment, the electronic card is arranged at least in part above the distributors.

This positioning of the electronic card allows not to impact the width or the length of the valve, therefore to benefit from a housing maintaining a standard size for its connection to a base despite the presence of the electronic card. This allows the use of the valve as a replacement for standard valves mounted on bases having a standard connection interface, for example in accordance with the standard ISO15407-2 or 5599-2.

According to one embodiment, the device comprises five orifices.

This characteristic makes it possible to use two orifices as pressurized air intake orifices and a single orifice as a purge orifice. Thus, this authorizes the use of differentiated pressure in the inlet.

According to one embodiment, the device comprises four two-orifices two-positions distributors.

This configuration with four 2/2 distributors allows the realization of a multitude of functions with standard and inexpensive distributors.

According to one embodiment, the distributors comprise a bistable actuator.

An advantage of using bistable actuators is to reduce energy consumption, since the switchover from one position to the other is controlled by a polarized pulse signal, that is to say pulses of positive or negative voltage responding respectively to the rising or falling edge of a positioning order.

According to one embodiment, the distributors comprise a proportional actuator.

This makes it possible to open more or less the inlet or outlet orifices of the distributors, so as to obtain proportionality in flow rate or in pressure relative to the pilot signal sent by the electronic card.

According to another aspect, the invention also relates to a fluid distribution assembly comprising a valve according to any of the preceding claims and a user terminal comprising a plurality of truth tables.

According to one embodiment, the user terminal comprises a program configured to allow a user to create a truth table and/or a transition mode.

Thus, the user may create functions, or truth tables, not existing in the library of truth tables, and adapted to his own needs.

According to a third aspect, the invention also relates to a method for using a valve having the aforementioned characteristics, comprising the steps of:
connecting the valve to a user terminal,
transferring a truth table from this user terminal to the electronic card of this valve.

This method allows a user to modify, at his discretion and according to his needs, the function performed by the valve according to the invention.

According to one embodiment, prior to the transfer step, a step of selecting a truth table among a library of predetermined truth tables or of creating a truth table via a program executed by the user terminal.

According to one possibility, the method comprises the use of two orifices of the housing for the pressurized fluid intake and of a single orifice of the housing for purging the fluid.

This use makes it possible to use different pressures at the inlet and therefore makes it possible to offer the user more possibilities.

Other characteristics and advantages of the present invention will emerge clearly from the detailed description below of an embodiment, given by way of non-limiting example, with reference to the appended drawings in which:

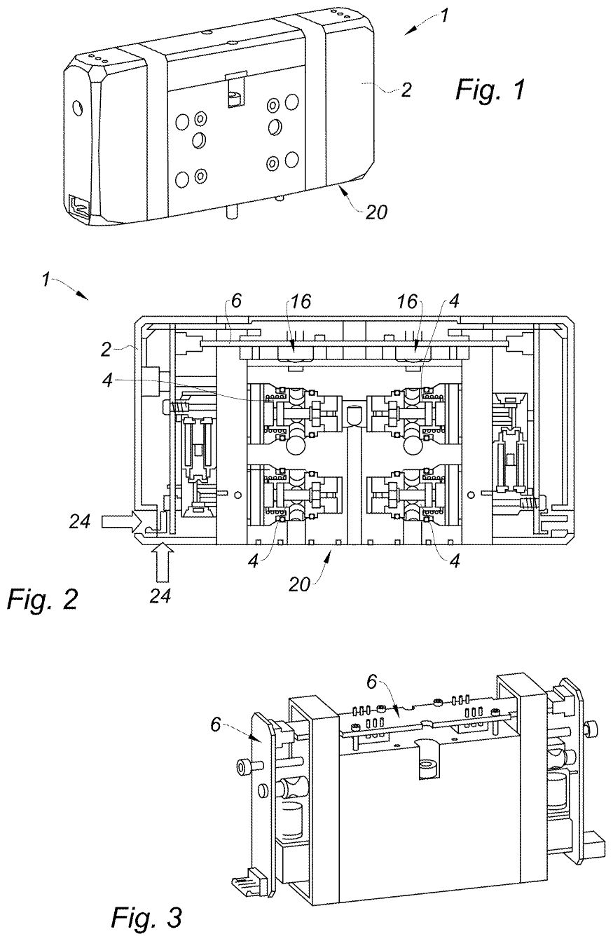

FIG. 1 is a perspective view of a valve according to an embodiment of the invention,

FIG. 2 is a sectional view of a valve according to an embodiment of the invention,

FIG. 3 is a perspective view of a valve according to an embodiment of the invention, without the housing,

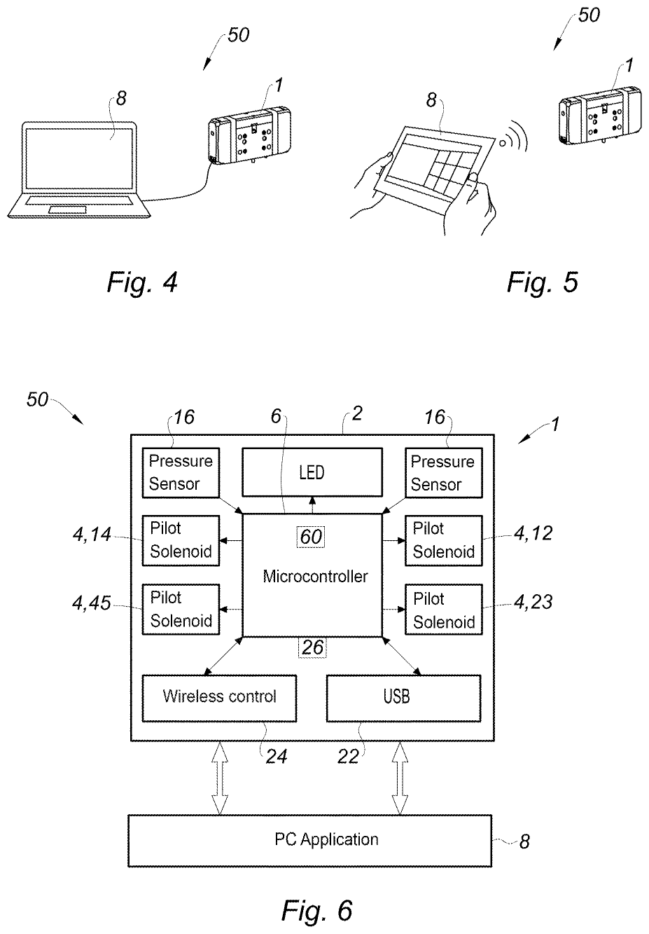

FIGS. 4 and 5 are perspective views of a device for distributing a fluid comprising a valve according to an embodiment of the invention,

FIG. 6 is a schematic view of a device for distributing a fluid comprising a fluid valve according to an embodiment of the invention,

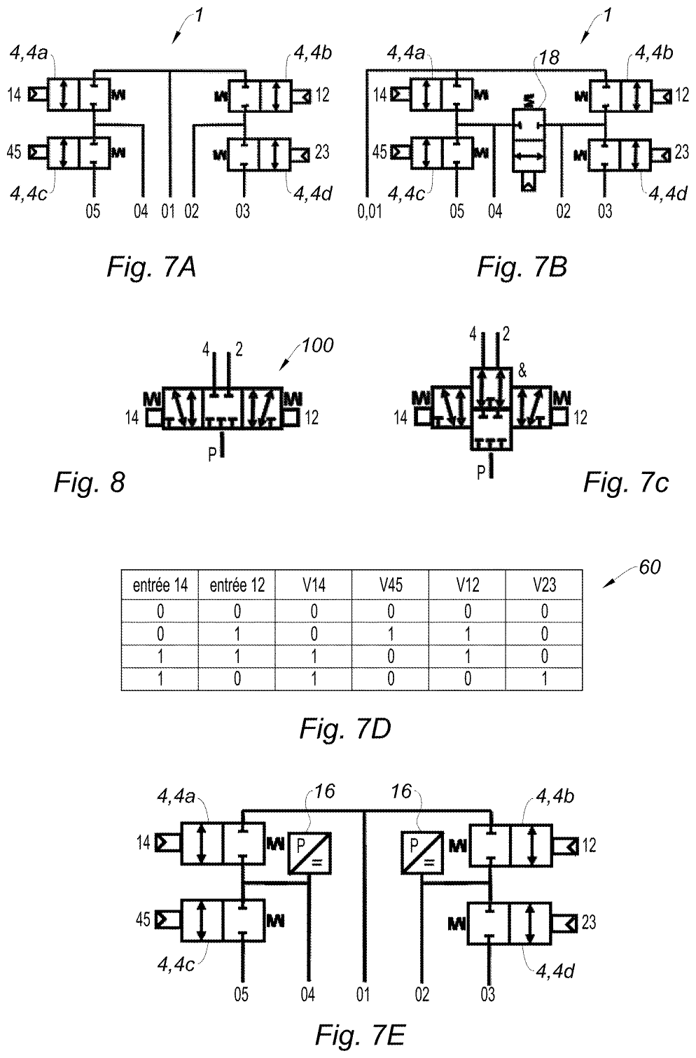

FIG. 7A is a schematic view of an arrangement of distributors of a valve according to an embodiment of the invention,

FIG. 7B is a schematic view of the arrangement of distributors of a valve according to FIG. 7A, including in addition a distributor for recycling fluids,

FIG. 7C is a schematic view of a 5/3 valve according to an embodiment of the invention,

FIG. 7D illustrates a truth table allowing a valve according to an embodiment of the invention to perform a predetermined function,

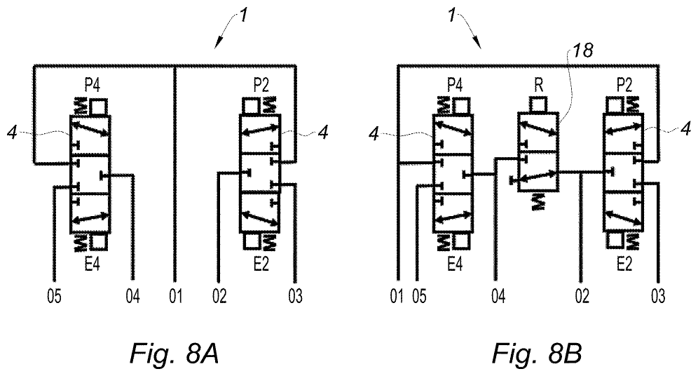

FIG. 8 is a schematic view of a function performed by a standard 5/3 distributor in comparison with the 5/3 valve according to FIG. 7C,

FIG. 8A is a schematic view of an arrangement of distributors of a valve according to an embodiment of the invention,

FIG. 8B is a schematic view of the arrangement of distributors of the valve according to FIG. 8A, including in addition a distributor for recycling the fluid,

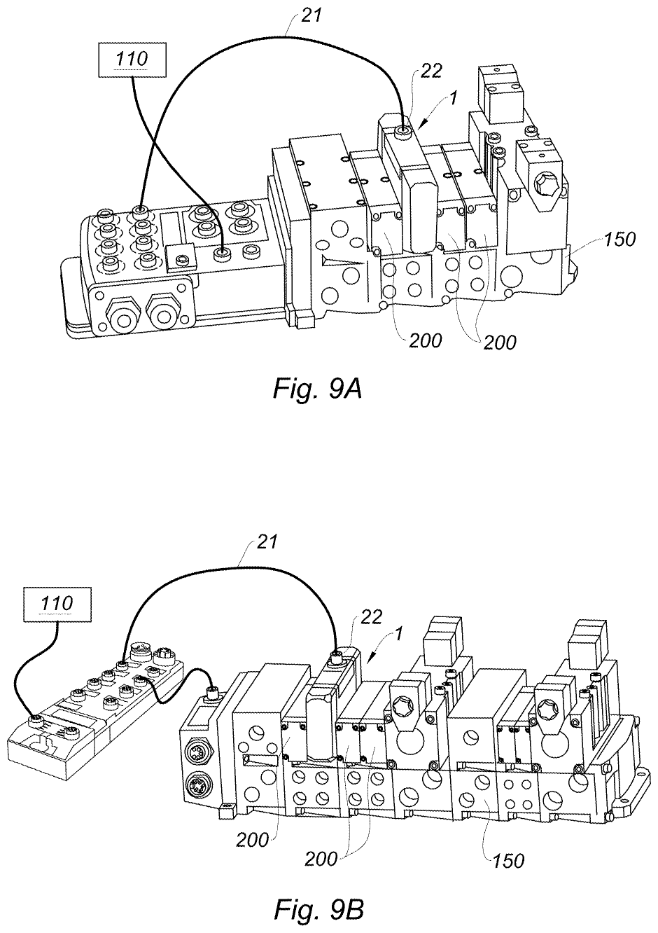

FIGS. 9A and 9B are perspective views of a device for distributing fluid comprising a fluid valve according to an embodiment of the invention.

FIG. 1 shows a valve 1, more precisely a solenoid valve, according to an embodiment of the invention, intended for the distribution of a fluid. The valve 1 may be a pneumatic or hydraulic valve.

The valve 1 is configured to be mounted on a base 150. The base is intended to bring pressurized fluid to the valve 1 and to establish a fluid connection between the valve 1 and one or more actuators, such as for example a pneumatic or hydraulic cylinder.

The valve 1 is an «all in one» valve, or universal valve, in the sense that this valve 1 is capable of performing several functions without needing to be replaced, as will be described in detail below. Particularly, the valve 1 alone may replace a conventional valve of the 3 or 5 orifices and 2 positions type as well as a conventional valve of the 5 orifices and 3 positions type.

The valve 1 comprises an outer envelope or housing 2, configured to be connected to the base, several ports or orifices O intended for the inlet or outlet of the fluid inside or outside the valve 1, at least two distributors 4 configured to monitor the circulation of the fluid inside the valve 1, and an electronic card 6 configured to store a truth table 60 (FIG. 7D) associating with each control signal received by the valve a predetermined positioning of the distributors 4 The control signals are conventionally transmitted to the valve 1 by a controller 110.

The housing 2 may be of a substantially parallelepiped shape. The housing 2 is for example sized to meet the standard ISO 15407-2 or 5599-2. This makes it possible to dispose of an all-in-one valve 1 which can be installed on a standard equipment in order to optimize costs, or which can replace valves 200 of standard dimensions or be associated with standard valves 200 as represented in FIGS. 9A, 9B. The housing 2 comprises a connection face 20 intended to be connected to the base. The orifices O preferably open on the connection face 20.

The electronic card 6 is arranged inside the housing 4. Preferably, the electronic card 6 is arranged on one side of the box 2 opposite to that where are formed the ports O which are intended to be connected to the base. Particularly, the electronic card 6 may be positioned above the distributors 4 relative to an axis A substantially orthogonal to the connection face 20 of the housing 2.

According to the example of the Figures, for example FIG. 7A, the valve 1 may comprise at least four orifices O, preferably five, among which at least one pressurized fluid inflow orifice O1 allowing the supply of the valve 1 with pressurized fluid, two fluid outlet orifices O2, O4 towards one or more actuators (not represented) such as a cylinder, and at least one exhaust orifice, preferably two exhaust ports O3, O5 allowing to purge the valve 1 of the fluid which circulates there.

As there are here two outlet orifices O2, O4 intended to be connected to an actuator, there are two possible outer control signals: a first control signal to control the flow rate of the orifice O2 and a second control signal to control the flow rate of the orifice O3. To these two control signals correspond four possible combinations, visible in FIG. 7D: absence of activation of the two signals, activation of the first control signal only, activation of the two control signals simultaneously, activation of the second control signal only.

The electronic card 6 comprises a microprocessor configured to translate each control signal received by the valve 1 into a pilot signal controlling a predetermined positioning of the distributors 4, as a function of the memorized truth table 60. The microprocessor therefore controls a positioning of the distributors 4 as a function of the memorized truth table 60.

To modify the truth table 60 stored in the microprocessor, and thus modify the function of the valve 1 without replacing it with another valve, the valve 1 comprises connection means configured to connect the electronic card 6 to a user terminal 8 which stores a library of predetermined truth tables 60, such as a computer, a tablet, a mobile phone, or a programmable logic controller PLC 110, in order to transfer another truth table to the electronic card 6. Thus, the valve 1 is configurable depending on the needs of the user. As symbolically represented in FIG. 6, the connection means may be wired, such as a connection port 22, for example of the M12 or USB connector type, and/or wireless, such as a communication unit 24 of the Bluetooth or Wi-Fi type. The connection port 22, in particular the M12 connector, is advantageously located on an upper face of the valve 1, that is to say opposite to a lower face intended to be connected to the base and where the ports O are formed, preferably the closest one to the electronic card 6.

As illustrated in FIGS. 9A, 9B, the connection means may include a gateway 21 of the IO-link type, making it possible to connect the valve 1 to the user terminal 8, in particular to the controller 110, for the setting of the valve 1 and/or the supply of the electronic card 6. The IO-link gateway 21 allows two-way communication: from the user terminal 8 to the valve 1 for sending and receiving truth tables 60, from the valve 1 to the user terminal 8 for status data such as the state of activation of the outlets by means of pressures at the outlet orifices, the number of cycles carried out or even the leakage levels or the response times by measuring the pressure variations.

The distributors 4 correspond to elementary functional blocks. The distributors 4 are arranged inside the housing 2. Each distributor 4 may connect at least two orifices O of the valve 1 for monitoring the circulation of the fluid inside the valve 1. The distributors 4 may be pneumatic or hydraulic distributors, for example solenoid valves. Each distributor 4 may comprise a body, an element (slide or valve) movable inside the body between at least two positions and an actuator 14, 45, 12, 23, for example a solenoid, configured to displace the movable element. The actuators are connected to the electronic card 6, as symbolically illustrated in FIG. 6.

Preferably, the distributors 4 are standard distributors. For example, the distributors 4 may be distributors of the 3 orifices 3 positions (FIG. 8A) or 2 orifices 2 positions (FIG. 7A) type.

In order to carry out all of the conventional pneumatic or hydraulic functions, the valve 1 may for example comprise a configuration with at least four distributors 4 of the 2/2 type (2 orifices, 2 positions), as represented in FIG. 7A. The distributor 4a connects the orifices O1 and O4, the distributor 4b the orifices O1 and O2, the distributor 4c the orifices O4 and O5, and the distributor 4d the orifices O2 and O3. By combining the actions of the distributors 4a, 4b, 4c and 4d, it is possible to reproduce any type of standard distributor, and in addition to add functions.

By way of comparative example, FIG. 8 illustrates a standard distributor 100 of the 5/3 type (5 orifices, 3 positions), whose central position is with plugged orifices. This standard distributor is also called closed center 5/3 distributor. This standard distributor offers three distinct states. According to a first state, the two control signals for the pilots 14, 12 are inactive, the distributor 100 is in the central position (FIG. 8). In a second state, only the pilot control signal 14 is active, the distributor 100 has switched over on the left block (has therefore been displaced to the right from the position in FIG. 8). According to a third state, only the pilot control signal 12 is active, the distributor 100 has switched over on the right block (has therefore been displaced to the left from the position in FIG. 8). There is no fourth state possible since the situation where the two control signals of the pilots 12, 14 are active simultaneously results in a result similar to the first state. However, the valve 1 with the configuration of FIG. 7A makes it possible to assign a different result depending on whether the two control signals are simultaneously active or inactive. Thus, as illustrated in FIGS. 7C and 7D, when the two control signals are inactive, the valve 1 takes the equivalent of a central position where all the orifices O are plugged; but when the two control signals are simultaneously active, the valve 1 takes a central position called with a center open to the exhaust, in which the orifices O2 and O4 are respectively in communication with the orifices O3 and O5. The truth table 60 associates with each combination of control signals a pilot signal activating or not activating the actuator 14, 45, 12, 23 of each of the distributors 4a, 4b, 4c, 4d.

Advantageously, the electronic card 6 may be configured to manage a transition mode of the distributors 4 from one position to another, among a plurality of transition modes or combinations of possible transition modes. In other words, the microprocessor of the electronic card 6 may be configured to decide on the order of opening or closing of the fluid circulation channels of the valve 1. To allow efficient management of the transition modes, in particular in order to optimize fluid transfers to reduce the response time of the valve 1, the valve 1 may include pressure or flow rate measurement means, such as pressure sensors 16, connected to the electronic card 6. For example, the pressure or flow rate measurement means may be arranged so as to measure a pressure or a flow rate at the level of the outlet orifices O2, O4, as represented in FIG. 7E.

The valve 1 may advantageously comprise means for recycling the fluid configured to recover at least one portion of the fluid purged by at least one of the distributors 4 when this distributor passes to another position. The recovered fluid is redirected to a second distributor 4 during the transition controlled by the pilot signal triggering the change of state.

As visible in FIG. 7B, the fluid recycling means may comprise a fluid recovery distributor 18, which for example connects the outlet orifices O2, O4. The fluid recovery distributor 18 is also connected to the distributors 4.

Indeed, when one of the outlet orifices O2 or O4 is pressurized to deliver pressure to the actuator, in the absence of recycling means, the fluid sent towards the other outlet orifice O4, O2 is conventionally purged, that is to say directed towards the exhaust orifice O5 or O3 respectively. The fluid, in particular the compressed air, previously used for pressurizing this outlet orifice O4, O2 is therefore lost. However, by integrating a switching between the ports O2 and O4, via the fluid recovery distributor 18, it becomes possible to partially reuse the volume of fluid used for pressurizing one of the two outlet orifices O2, O4 for a second action towards the other outlet port O2, O4, and therefore to save energy. This recycling function could be activated in the transition phases between stable states.

In the case of an activation of the recycling function, the switchover from the state in which the first outlet port is pressurized and the second outlet port is exhausted, to the state in which the first port is exhausted and the second port is pressurized, or vice versa, is done in three stages: the switching of the distributor 18 is first open to allow the exchange of fluid between the outlet ports until a pressure or flow rate conditional threshold is reached; the switching of the distributor 18 is then returned to the closed position, before the appropriate distributor 4 is activated to complete and finish the establishment of the fluid passage.

The fluid recovery distributor 18 may be a distributor similar to the distributors 4, in order to reduce the cost of the valve 1. According to the example of FIG. 7B, the fluid recovery distributor 18 is thus of a two orifices two positions 2/2 type.

The actuators of the distributors 4, and where appropriate of the fluid recovery distributor, may comprise an electromagnet, for example a solenoid.

The actuators of the distributors 4, 18 may be of the monostable type, also called «on/off distributor». These actuators have a stable state which corresponds to the non-excitation of the electromagnet and therefore to the resting state, and an unstable state dependent on the excitation of the electromagnet and corresponding to the establishment of the pilot signal. The activation of the actuator managed by the electronic card 6 requires maintaining the pilot signal; said pilot signal may however be optimized by the application of an advanced electrical signal, either at two levels, namely an inrush voltage then a hold voltage, or in switched-mode, namely pulsed at an adequate frequency (Pulse Width Modulation).

The actuators of the distributors 4, 18 may be of the bistable type. These actuators have two stable states, one corresponding to the resting state and the other to the state of establishment of the pilot signal. The switchover from one state to another is done by the application of a polarized pulse signal. The passage from one state to another is made by detection of a rising or falling edge of the control signal. This actuator type allows reducing the consumed energy.

The actuators of the distributors 4, 18 may be of the proportional type. These actuators allow adopting a relative state between the resting state and the state of establishing the complete pilot signal, in proportion to a recorded electrical control signal (0-10V or 5-20 mA). These actuators therefore allow a pressure regulation.

Depending on the actuator type, the electronic card 6 is configured to deliver the appropriate pilot signal to each actuator.

The valve 1 may further comprise supply means configured to provide the electronic card 6 with a constant energy source allowing the operation thereof. For example, the supply means may comprise a supply port 24 allowing plugging an electrical power supply cable thereinto. According to another possibility, the supply means may comprise an electric energy storing element 26 embedded in the housing 2 and configured to provide the energy necessary for the operation of the electronic card 6, such as for example a battery or a capacity. This could be particularly advantageous with bistable actuators of the distributors 4, 18.

A valve in accordance with the standard ISO 15407-2 or 5599-2 comprises a four-point electrical connector, three of which are used for the transmission of control signals. The fourth contact of this connector may therefore be used to bring the continuous energy source necessary for the operation of the electronic card 6, therefore serving as a supply port 24. Thus, the valve 1 may be compatible with the standard ISO 15407-2 or 5599-2 and may be mounted on standard bases, since the three connection points defined in the standard remain unchanged. As illustrated in FIGS. 4 to 6, the invention also concerns a device 50 for distributing a fluid comprising a valve 1 as described above, as well as a user terminal 8, such as a computer, a tablet, a mobile phone or a programmable logic controller PLC 110, which stores a library of predetermined truth tables 60. The user terminal 8 comprises an interface allowing the user to select a truth table 60 from the library of truth tables 60. Thus, by connecting this user terminal 8 to the valve 1, it is possible to change the truth table 60 which is previously stored in the electronic card 6 by another truth table 60 among the truth tables 60 stored on the user terminal 8.

The user terminal 8 comprises a program which is advantageously configured to further allow a user to create a truth table 60 and add it to the library of truth tables 60 via the user interface. In addition, the program may be configured to allow the user to define a transition mode. Thus, the user may create functions, or truth tables, which are not existing in the library of truth tables, and adapted to his own needs. The valve 1 is thus programmable.

The invention also concerns a method for setting the valve 1 described above. This method comprises the steps of:
connecting the valve 1 to the user terminal 8, in particular via connection means,
transferring a truth table 60 from the user terminal 8 to the microprocessor of the electronic card 6 of the valve 1.

Prior to the transfer step, or even to the connection step, the method may comprise a step of selecting, by the user, a truth table 60 from a library of predetermined truth tables 60 stored on the user terminal 8. Thus, the user has access to a pre-saved library of commonly used hydraulic or pneumatic functions.

Prior to the transfer step, or even to the connection step, the method may comprise a step of creating a truth table 60 via a program installed on the user terminal 8. This truth table 60 may be added to the library of truth tables 60 of the user terminal 8. The user may thus set the valve 1 with very specific and non-existent functions.

The method may also comprise a step of creating a transition mode by the user via the program installed on the user terminal 8. Thus, the user may specify and change transition modes when the valve 1 passes from one position to another, which is not possible with the standard valves. In other words, the user may define the order of opening or closing the fluid circulation channels in the valve 1, during the passage from one state to another.

Of course, the invention is not limited to the embodiment described above, this embodiment having been given only by way of example. Modifications are possible, in particular with regard to the constitution of the various devices or by the substitution of technical equivalents, without departing, for all that, from the field of protection of the invention.

Thus, the valve 1 is, for example, not limited to an arrangement of four or five 2/2 type distributors 4, 18, but could comprise an arrangement of two or three three-orifices three-positions 3/3 type distributors 4, 18, as shown in FIGS. 8A and 8B.

1. A valve intended to be mounted on a base for controlling the distribution of a fluid, this valve comprising a housing and several orifices, these orifices being intended for the inlet or outlet of the fluid inside the housing, characterized in that the valve comprises a plurality of distributors arranged in the housing to control the circulation of the fluid inside the valve, and in that the valve comprises an electronic card arranged in the housing, the electronic card being configured to store a truth table associating a predetermined positioning of the distributors with each control signal received by the valve, wherein the electronic card is configured to manage a transition mode of the distributors from a position to another.

2. The valve according to claim 1, wherein the valve comprises connection means configured to allow connecting the electronic card to a user terminal in order to transfer a truth table from the user terminal to the electronic card.

3. The valve according to claim 1, wherein the valve comprises fluid recycling means configured to recover at least one portion of the fluid purged by one of the distributors for its reuse.

4. The valve according to claim 1, wherein the valve comprises pressure or flow rate measuring means connected to the electronic card.

5. The valve according to claim 1, wherein the valve comprises an electric energy storing element embedded in the housing and configured to supply energy to the electronic card.

6. The valve according to claim 1, wherein the electronic card is arranged at least partially above the distributors.

7. The valve according to claim 1, wherein the valve comprises five orifices.

8. The valve according to claim 1, wherein the valve comprises four two-orifices two-positions distributors.

9. The valve according to claim 1, wherein the distributors comprise a bistable actuator.

10. The valve according to claim 1, wherein the distributors comprise a proportional actuator.

11. A device for distributing a fluid comprising a valve according to claim 1 and a user terminal comprising a plurality of truth tables.

12. The device according to claim 11, wherein the user terminal comprises a program configured to allow a user to create a truth table and/or a transition mode.

13. A method for parameterizing a valve according to claim 1, comprising the steps of:
connecting the valve to a user terminal,
transferring a truth table from this user terminal to the electronic card of this valve.
